(19) United States
(12) Patent Application Publication
(10) Pub. No.: US 2026/0034835 A1
(43) Pub. Date: Feb. 5, 2026

(54) APPARATUS AND SYSTEM FOR A TRACTION BOARD

(71) Applicant: SCOUT MOTORS INC., Tysons, VA (US)

(72) Inventor: Pat Vostal, Tysons, VA (US)

(21) Appl. No.: 18/794,817

(22) Filed: Aug. 5, 2024

(51) Int. Cl. B60B 39/12; B60R 7/02

(52) U.S. Cl. CPC B60B 39/12; B60R 7/02

(57) ABSTRACT

Provided herein is a system and for a traction board, and more specifically, a traction board that can be incorporated into components of a vehicle that serve at least one other purpose. A vehicle is provided that includes a storage compartment, where the storage compartment is disposed below a load floor of a cargo area of the vehicle; and a traction board cover for the storage compartment, where the traction board cover defines a first major surface and a second major surface, where at least one of the first major surface and the second major surface defines a first plurality of lugs extending away from the at least one of the first major surface or the second major surface, where the traction board cover defines at least one handle.

### BACKGROUND

Wheeled vehicles employ one or more wheels to traverse a surface. The movement of such a vehicle is generally created by at least one of the wheels being driven by a power source. That driven wheel, inclusive of a tire where appropriate, contacts the ground, and due to frictional engagement with the ground, pushes the vehicle based on a rotation of the wheel relative to the ground. This straightforward concept assumes frictional engagement between a vehicle wheel and the surface along which the wheel is traveling. However, in some circumstances there is insufficient friction between the wheel and the surface, such that the driven wheel fails to push the vehicle forward at a speed corresponding to a rotational speed of the wheel. In such circumstances, a traction aid may be used to enhance the traction between the vehicle wheel and the surface. In some cases, this traction aid may be in the form of a traction board. A traction board is a somewhat rigid device that is able to frictionally engage both a vehicle wheel and the surface over which the vehicle is traveling to enable the wheel to frictionally engage the surface and propel itself.

### BRIEF SUMMARY

A system and apparatus are therefore provided for a traction board, and more specifically, a traction board that can be incorporated into components of a vehicle that serve at least one other purpose. Some embodiments provided herein include a vehicle including a storage compartment, where the storage compartment is disposed below a load floor of a cargo area of the vehicle; and a traction board cover for the storage compartment, where the traction board cover defines a length and a width, where the length is greater than the width; where the traction board cover defines a first major surface and a second major surface, where at least one of the first major surface and the second major surface defines a first plurality of lugs extending away from the at least one of the first major surface or the second major surface, where the traction board cover defines at least one handle, where the at least one handle is at least one of formed into the traction board cover or collapsible to be flush with or below the at least one of the first major surface and the second major surface.

According to some embodiments the traction board cover is removable and configured to flex under a weight of at least one wheel of the vehicle. According to certain embodiments the storage compartment defines a rim proximate a top of the storage compartment, where the traction board cover is configured to be seated on the rim within a recess of the load floor. The traction board cover of some embodiments is formed of a plastic material reinforced with at least one of fibers or particulate fillers.

According to certain embodiments at least one of the first major surface and the second major surface defining the first plurality of lugs extending away from the at least one of the first major surface or the second major surface includes: the first major surface defining the first plurality of lugs extending away from the first major surface, and the second major surface defining a second plurality of lugs extending away from the second major surface. According to some embodiments the first plurality of lugs extends a first distance away from the first major surface, the second plurality of lugs extends a second distance away from the second major surface, and the first distance is greater than the second distance.

The length is defined, in some embodiments, between a first end of the traction board cover and a second end of the traction board cover, where the first end of the traction board cover defines a concavity for use as a shovel. According to certain embodiments the second end of the traction board cover defines a handle that, in combination with the concavity of the first end, renders the traction board functional as a shovel. A mid-section of the traction board cover of some embodiments defines a first thickness, where the length is defined between a first end of the traction board cover and a second end of the traction board cover, where the first end of the traction board cover tapers from the first thickness to a second thickness, and where the second thickness is less than the first thickness. According to some embodiments the length is defined between a first end of the traction board cover and a second end of the traction board cover, where the traction board cover defines one or more ribs extending between the first end and the second end. According to certain embodiments the traction board cover includes a first traction board cover, where the vehicle further includes a second traction board cover for the storage compartment, where the traction board cover defines a length and a width, and the length is greater than the width.

Some embodiments provided herein include a traction board for a vehicle including: a traction board body, where the traction board body defines a first major surface and a second major surface, where the traction board body defines a first end, a second end, a mid-section between the first end and the second end, and a perimeter about the traction board body; a first plurality of lugs extending away from at least one of the first major surface or the second major surface; and at least one handle defined within the traction board body, where the traction board body is configured to be received within a recess of a vehicle load floor, and where the traction board body covers a storage compartment below the vehicle load floor.

The traction board body of some embodiments is formed of a plastic material reinforced with at least one of fibers or particulate fillers. The traction board of some embodiments further includes a second plurality of lugs extending away from another of the at least one of the first major surface or the second major surface. According to some embodiments the first plurality of lugs extends a first distance away from the first major surface, the second plurality of lugs extends a second distance away from the second major surface, and the first distance is greater than the second distance.

According to certain embodiments the first end of the traction board cover defines a concavity for use as a shovel. The second end of the traction board of some embodiments defines a handle that, in combination with the concavity of the first end, renders the traction board functional as a shovel. According to some embodiments a mid-section of the traction board body defines a first thickness, where the first end of the traction board body tapers from the first thickness to a second thickness, and where the second thickness is less than the first thickness. According to certain embodiments the traction board body defines one or more ribs extending between the first end and the second end.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a diagram of a vehicle traveling in loose or high viscosity terrain according to an example embodiment of the present disclosure;

FIG. 2 illustrates the diagram of FIG. 1 with the benefit of a traction board according to an example embodiment of the present disclosure;

FIG. 3 illustrates the diagram of FIG. 3 with the vehicle using the traction board according to an example embodiment of the present disclosure;

FIG. 4 illustrates a configuration of a storage location within a vehicle according to an example embodiment of the present disclosure;

FIG. 5 illustrates a storage compartment including a traction board cover according to an example embodiment of the present disclosure;

FIG. 6 illustrates a traction board cover according to an example embodiment of the present disclosure;

FIG. 7 illustrates a traction board cover according to another example embodiment of the present disclosure; and

FIG. 8 illustrates a storage compartment having two traction board covers according to an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Automobiles including vehicles such as trucks, cars, sport utility vehicles (SUVs), crossovers, etc., rely on traction between their tires and the surface in contact with the tires to propel the vehicle. Automotive tires are generally designed for specific functionality, with some tires being better for paved road surfaces and possibly different seasons of the year, while other tires may be designed for more rugged terrain, such as off-road or unimproved road surfaces (e.g., dirt roads, rocky/gravel roads, etc.). Tires designed to be superior in a certain terrain may be sub-standard for other terrains. For example, tires design for maximum off-road traction may have poor traction on asphalt roads and particularly wet asphalt roads.

Regardless of the type of vehicle, the type of tire, and the terrain, there will be combinations that result in poor traction and potentially zero traction for the driven wheels on the terrain. Vehicle control systems, such as traction control, are limited in their functionality particularly with respect to frictional engagement between the wheels and terrain. Thus, traction aids may be employed to increase frictional engagement between wheels and terrain. Traction aids come in various forms, including abrasives (e.g., sand used on ice) and snow chains among others. One type of traction aid that is generally used in off-road environments are traction boards.

When traveling off-road, it is not uncommon for a vehicle to become stuck, where one or more driven wheels of the vehicle lose traction with the terrain. This loss of traction can occur in sand, mud, snow, etc. A vehicle without a locking differential may become stuck with only a single driven wheel losing traction. Even with a locking differential, a vehicle with two driven wheels that have lost traction may still be stuck. When this occurs, the vehicle may cease to move. In such an instance, a traction board may be used to help the vehicle drive free of the stuck position.

Traction boards are semi-rigid boards that are inserted at least partially under a wheel proximate a bottom of the wheel, which is generally the contact patch between the tire and the terrain. Traction boards are used to provide traction to a tire of a wheel as it turns against a top of the traction board, while the bottom surface of the traction board engages the terrain. This mutual engagement of the traction board between the tire and the terrain enables the driven wheel to grab the traction board and advance from the stuck position.

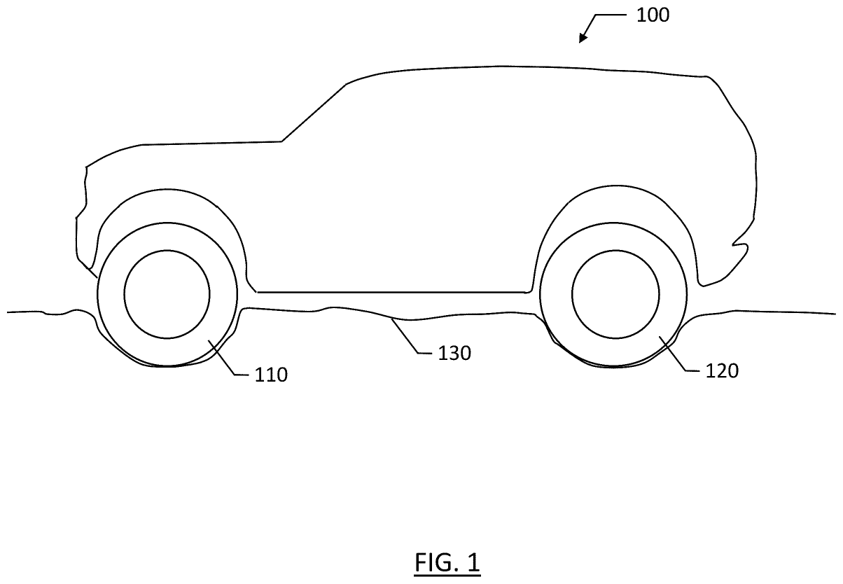

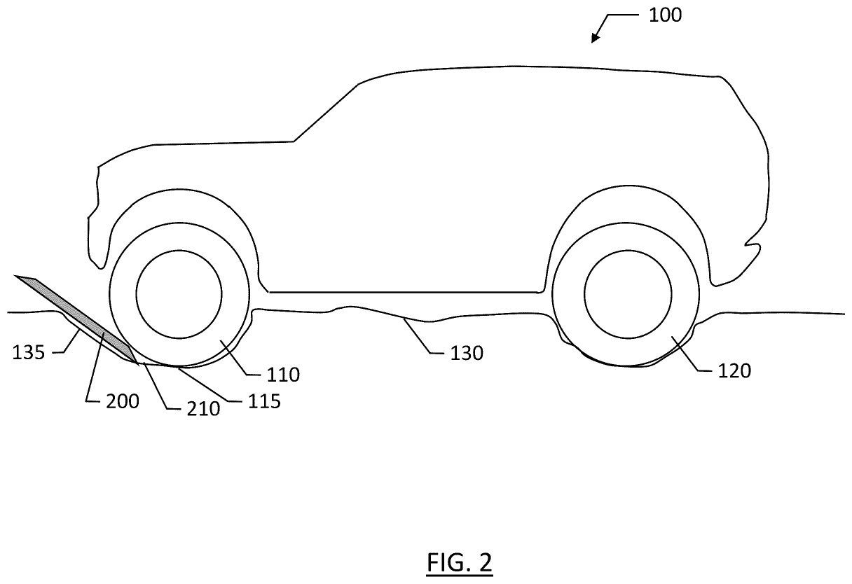

FIG. 1 illustrates an example embodiment of a vehicle 100 traveling along terrain 130. The terrain may be soft (e.g., dry, loose sand), where the vehicle may become stuck when the wheels lose traction with the terrain. As shown, the front wheel 110 and back wheel 120 have become stuck, and in the illustrated embodiment have sunk into the terrain 130. This situation can occur, for example, when wheels spin in loose sand or in mud with low viscosity. To regain traction, a traction board may be used. FIG. 2 illustrates the stuck vehicle 100 of FIG. 1, with a traction board 200 inserted ahead of the front wheel 110. As shown, the hole in the terrain into which the front wheel 110 is sunk may be at least partially dug out at 135 to provide room to insert the traction board 200 into position. A first end 210 of the traction board 200 may be inserted to a position proximate a contact point 115 between the weight of the vehicle and the terrain. While a wheel that is sunk into a hole or ditch may contact terrain about a significant portion of the tire surface, the primary contact point is found where substantial weight is applied from the vehicle through the wheel into the terrain. Thus, the primary contact point is typically directly below the wheel, but in some instances can be more forward or aft based on the terrain itself.

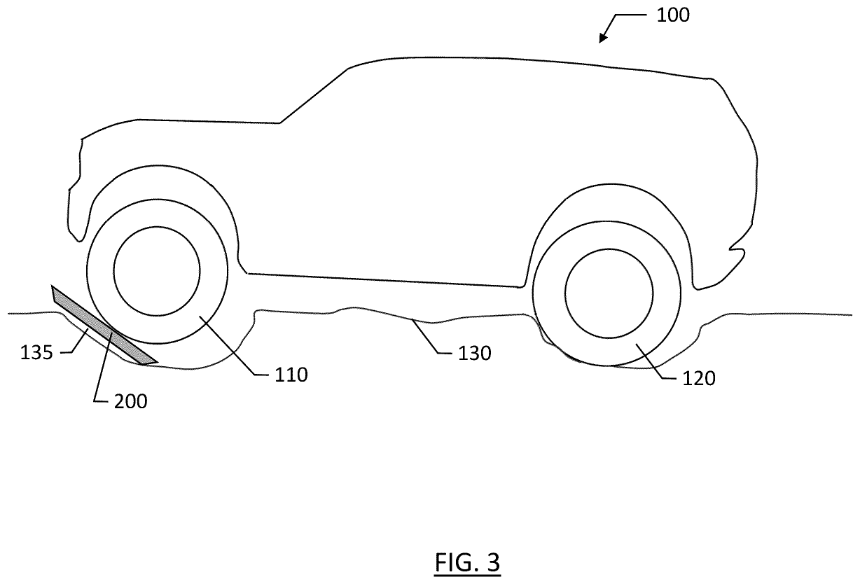

Once the traction board 200 is inserted, the vehicle may drive forward. In the illustrated embodiment of FIG. 2, at least the front wheel 110 is driven, as the traction board functionality is only available when used with a driven wheel. When the front wheel 110 rotates forward it frictionally engages a top side of the traction board 200 and presses a bottom side of the traction board against the terrain 130. For terrain of loose sand, the traction board 200 presses against a substantial contact patch with a relatively static force, such that the sand supports the traction board and the weight of the wheel of the vehicle on the traction board is distributed across the contact patch of the traction board with the terrain. The top side of the traction board 200 may include a texture to encourage friction between the wheel and the traction board. This combination of effects enables the vehicle to drive out of the loose terrain. FIG. 3 illustrates this result as the vehicle 100 ascends the traction board 200 to cease to be stuck.

Traction boards as described herein are useful in many situations. However, they are relatively large and cumbersome, such that they are not readily stored in most vehicles without substantial loss of cargo space. Certain embodiments described herein provide a traction board that also functions as a useful component of a vehicle, thereby mitigating storage concerns and ensuring a traction board is readily available with the vehicle when needed.

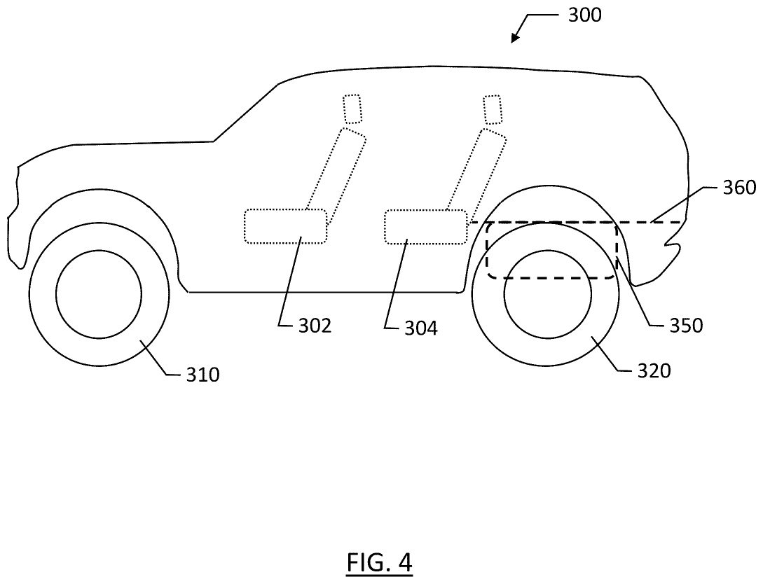

FIG. 4 illustrates a profile of a vehicle 300 that in the depicted embodiment can include an electric vehicle. Electric vehicles have different powertrain components than conventional internal combustion engine (ICE) vehicles and different mechanisms to convey power. For example, an electric vehicle includes at least an electric motor controlled by a controller and powered using batteries. These different components can be located proximate one another or in different positions, and all connected by wires and power cables.

Conventional ICE vehicles require a fuel tank, an engine, a transmission, and axles, transaxles, and/or driveshafts to transmit power from the transmission to the driven wheels. These components have less flexibility in positioning within a vehicle due to their size, required relative positions, and the mechanical couplings required from the engine through to the wheels. For example, in a conventional ICE vehicle with a front-mounted engine, a fuel tank is often positioned between the rear wheels 320. This position is used for safety as the stiffness of the rear axle and/or suspension components along with the structure of the wheels and wheel wells provide additional protection relative to a position aft of the rear wheels.

For electric vehicles, such a fuel tank is not required. Further, the battery, while benefiting from a position low in the vehicle to lower a center of mass of the vehicle, can be configured in a variety of ways that are not limited as with a fuel tank. This positioning of the battery frees up space between the rear wheels 320. The space 350 between the wheels is limited in width due to suspension components inboard of the rear wheels and the wheel arches themselves. Some embodiments described herein use this space 350 as a storage compartment which can be useful for storing a wide variety of articles. This space 350 in the illustrated embodiment is disposed below a load floor 360 of a cargo area of the vehicle behind a second row seat 304, which is behind the front seat 302. It should be appreciated that the space 350 could alternatively be disposed below behind a third row seat (e.g., behind the second row seat 304) in larger vehicles with a third row of seating.

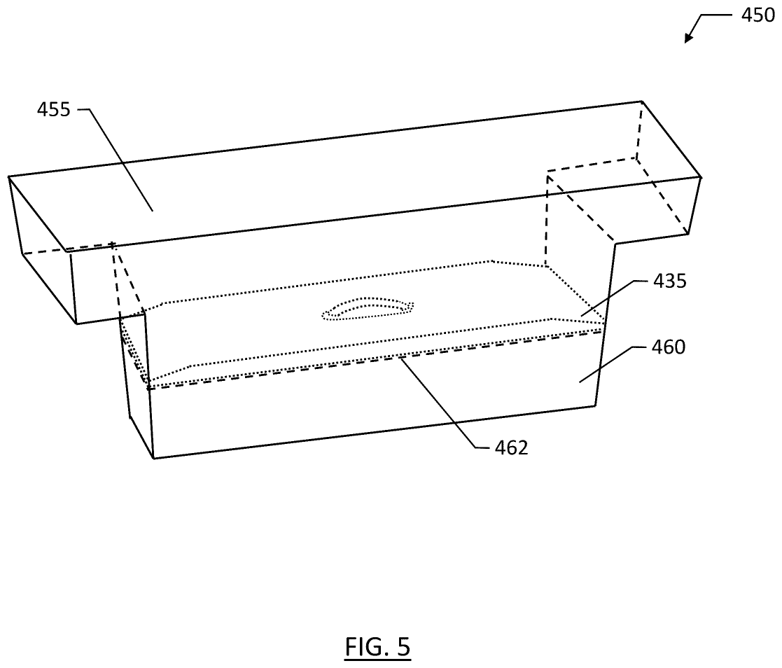

FIG. 5 depicts a semi-transparent perspective view of the storage compartment 450 of an example embodiment that can be positioned in the location shown as space 350 in FIG. 4. The shape of the storage compartment of the illustrated embodiment is one example of how such a storage compartment could be configured. As shown, the storage compartment 450 includes an upper compartment 455 and a lower compartment 460. The upper compartment 455 may be disposed, for example, below the load floor 360 shown in FIG. 4. The load floor may be hinged or otherwise operable by a user to access the upper compartment 455 of the storage compartment 450. Also shown is a lower compartment 460 that is disposed below the upper compartment 455 and separated from the upper compartment by a traction board cover 435.

The upper compartment 455 is more easily accessed than lower compartment 460. In some embodiments lower compartment 460 may be used to store vehicle accessories and service tools or equipment. For example, lower compartment 460 may include a jack and a tire iron, also known as a lug wrench. Also included may be a first aid kit, emergency flare and/or reflective triangle, tow rope, etc. These articles may not be as frequently used as objects that are required to be more readily accessible.

The lower compartment 460 may include a rim 462 proximate a top of the lower compartment on which the traction board cover 435 may rest. The rim 462 may extend around four sides of the lower compartment 460 but need not be continuous. Further, according to some embodiments the rim may only be present on two opposing sides of a top of the lower compartment. In such a scenario, the traction board cover 435 is sufficiently strong to support the weight of most any object that would fit within the upper compartment 455 given the traction board functionality requirement of the traction board cover 435.

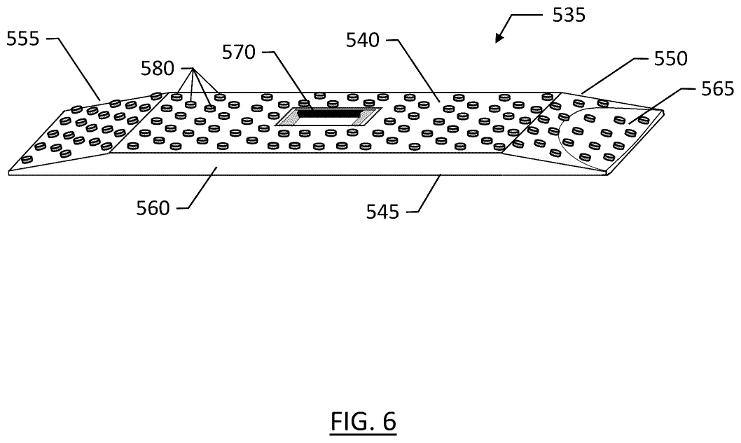

FIG. 6 illustrates an example embodiment of a traction board cover 535 as described herein. As shown, the traction board cover 535 includes a first major surface 540 and a second major surface 545 opposite the first major surface. The traction board extends along a length between a first end 550 and a second end 555, with the length being greater than the width in a direction perpendicular to the length. In many cases, as in the illustrated embodiment, the length is more than twice the width. Also shown in the embodiment of FIG. 6 is a handle 570. The handle 570 depicted is a folding handle that is collapsible, such as by being hinged to lay flat within a pocket defined within the first major surface 540. Once collapsed, the folding handle may be flush with or below the first major surface 540. Optionally, the handle could be a flexible material recessed into the first major surface 540 rather than the hinged handle as shown. In other embodiments, there may not be a separate handle, but the traction board may have one or more pockets or apertures defined in a body of the traction board configured such that a person may grab and lift the traction board cover from the storage compartment and carry the traction board cover to the location of use.

The first end 550 and the second end 555 of the traction board cover 535 of FIG. 6 are tapered forming ramped ends. This tapering can improve the functionality of the traction board cover as a traction board, as it is beneficial to position an end of the traction board cover 535 as close to a contact point between the terrain and a vehicle wheel as possible, and a reduced overall thickness of the traction board cover at the first end 550 and/or the second end 555 can facilitate this positioning. The central portion 560 between the first end 550 and the second end 555 is thicker than the tapered ends in order to appropriately support a weight of the vehicle as the traction board cover is used. The traction board cover 535 of the illustrated embodiment thus tapers from a first thickness at the central portion 560 to a second thickness at the first end 550, where the second thickness is less than the first thickness. The traction board cover also tapers at the second end 555, though the degree of taper may be different from that of the first end 550 in some embodiments. The thickness at the second end 555 to which the traction board cover 535 tapers may be the same as the second thickness or may be a third thickness, different from the first thickness but still less than the first thickness. It is not necessary for both ends of the traction board cover 535 to be tapered; however, in many embodiments they are to promote ease of use and to enable a smoother ascent and descent from the traction board cover during use.

The traction board cover 535 of FIG. 6 further illustrates a feature of the first end 550 with may be present in some embodiments. As shown, the first end 550 includes a concavity 565. The concavity may be present in both ends, one end as shown, or in some embodiments not included. The concavity 565 is configured to function as a shovel to aid in positioning of the traction board cover 535. Referring back to the illustration of FIG. 2, the terrain 130 was dug-out in front of the front wheel 110 to accommodate the traction board 200. In some embodiments, the second end 555 of the traction board cover 535 may include a handle to further aid the traction board cover to function with the concavity 565 as a shovel.

Also shown in FIG. 6 is a texture on the first major surface 540 in the form of lugs 580 extending a height away from the first major surface. These lugs 580 can be of a variety of shapes but are preferably relatively coarse to encourage traction between the wheel of a vehicle and the first major surface 540 of the traction board cover 535. The second major surface 545 of the traction board cover 535 may also include a textured surface to ensure grip with the terrain. Further, the traction board cover 535 may be used with either major surface facing up, such that the grip-enhancing texture may be on both major surfaces. In some embodiments, one side may have more aggressive lugs than the other, such as an embodiment in which a first plurality of lugs extend a first distance away from the first major surface 540 and a second plurality of lugs extend a second distance away from the second major surface 545, and in which the first distance is greater than the second distance. To this point, in such embodiments, the texture of the second major surface 545 is less aggressive than the texture of the first major surface 540, since the second major surface 545 serves as the load floor of upper compartment 455 when installed and therefore is configured to support articles placed into upper compartment 455, ideally without damaging the articles due to too aggressive of a texture. In other embodiments, both sides of the traction board cover 535 have the same grip-enhancing texture.

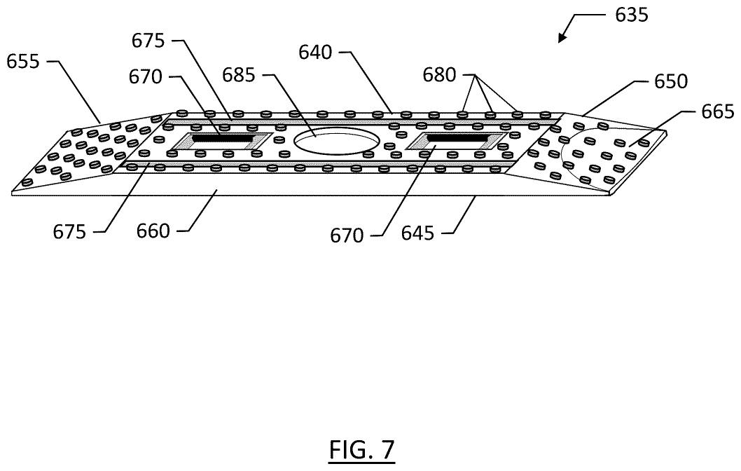

FIG. 7 illustrates another example embodiment of a traction board cover 635 including a first major surface 640, second major surface 645, first end 650, and second end 655 with a center section 660 disposed therebetween. Also shown is the concavity 665 at the first end 650. The embodiment of FIG. 7 differs from the embodiment of FIG. 6 as there are two handles 670 disposed in the traction board cover 635. The handles 670 may aid a user in removal of the traction board cover 635 from the cargo area of the vehicle and in positioning the traction board cover for use. Also present is a jack receiver 685. The jack receiver 685 of the illustrated embodiment is a recess sized to receive therein the base of a jack, such as a jack that is stored in the lower compartment of the storage compartment area. The shape and size of the jack receiver 685 may correspond to the size and shape of the jack base such that the jack fits securely within the receiver. In this way, the traction board cover 635 may additionally function as a jack plate.

A jack plate, such as the traction board cover 635, helps maintain a position of a jack when placed under a vehicle to lift the vehicle. Further, the traction board cover having a large footprint relative to a jack base can distribute the weight over a greater area, such that the jack can be used in combination with the traction board cover 635 functioning as a jack plate on a surface where a jack alone would not work well, such as on surfaces such as sand, dirt, a soft shoulder of a roadway, etc. Additionally, for vehicles designed to be used off-road the vehicle frame or jack point is generally elevated relative to the frame or jack point of a conventional car. As such, the traction board cover 635 provides additional functionality in elevating the jack from the ground toward the vehicle. This elevation results in less required jack travel to engage and lift the vehicle, thereby saving time and effort, while also stabilizing the jack on the traction board cover.

The traction board cover 635 of FIG. 7 further includes ribs 675 extending along a length of the body. These ribs may be recessed or raised, but provide additional structural rigidity to the traction board cover. Depending on the material, the ribs may be used to help reduce a weight of the traction board cover 635. For example, if the traction board cover was formed of injection molded plastic material, the ribs may provide a necessary structural feature that ensures the traction board cover 635 does not collapse under the weight of a vehicle using the traction board cover.

The traction board covers described may be formed of a variety of materials, such as reinforced plastics, composite materials, metal, etc. The traction board covers of some example embodiments are sufficiently light weight to be moved by a single person, such as when lifting the traction board cover from the storage compartment. However, the traction board covers are also configured to be strong enough to support at least a portion of a vehicle of significant weight (e.g., 6,000 lbs) as off-road vehicles can be heavy, particularly when laden with equipment or when electrified and carrying battery pack(s).

While the traction board can be of a wide variety of materials, the traction board will generally be somewhat flexible, particularly under heavy loads. The traction board covers described herein may bend to some degree when carrying a weight of a portion of the vehicle in which they are stored. This flex can help the traction board cover contact more of the surface of a tire as a vehicle is driving out of a stuck position. However, the traction board covers described herein are sturdy and flex only to a degree under such weight.

The size of the traction board cover of an example embodiment described herein can vary, but generally may be around 30 to 50 inches long, and 6 to 10 inches wide. Some embodiments may be longer, shorter, wider, or narrower. However, the traction board cover should be wide enough to support a wheel of a vehicle carrying the traction board cover.

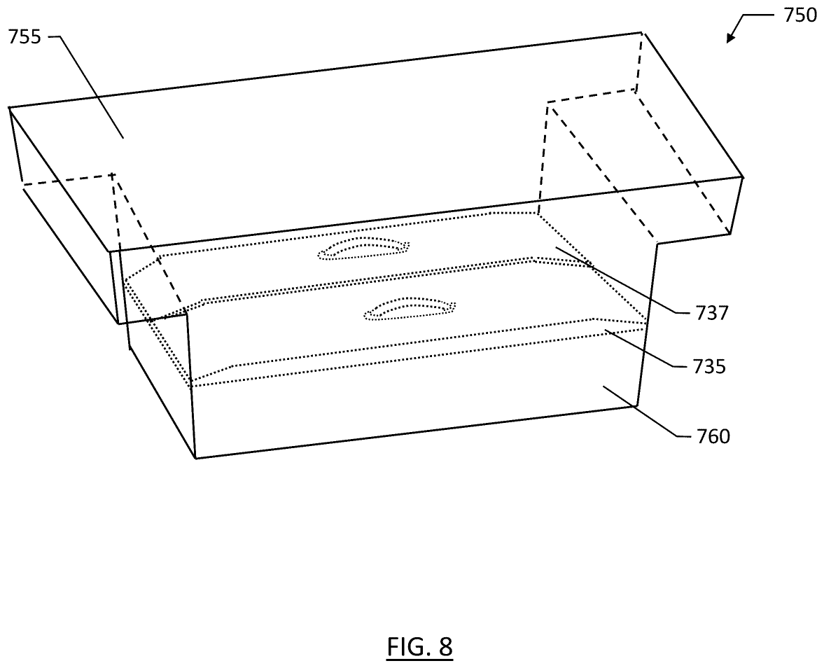

According to some embodiments, there may be more than one traction board cover stored as an interior panel of a vehicle. FIG. 8 illustrates an example embodiment in which a storage compartment 750 includes an upper compartment 755 and a lower compartment 760 as in FIG. 5. However, the storage compartment is sufficiently sized to include a first traction board cover 735 and a second traction board cover 737. As shown, first traction board cover 735 and second traction board cover 737 may be sized so as to be positioned side-by-side when positioned in storage compartment 750. Alternatively, in some implementations, first traction board cover 735 and second traction board cover 737 may be configured to stack such that first traction board cover 735 is positioned on top of second traction board cover 737 when positioned in storage compartment 750. In some such implementation, first traction board cover 735 and second traction board cover 737 can include corresponding alignment elements (not shown) to facilitate stacking. For example, the texture or pattern on the second major surface of first traction board cover 735 may interface with the texture or pattern on the first major surface of second traction board cover 737. Regardless, these traction board covers can each be similarly configured and embodied by the traction board cover described in greater detail above. Two traction board covers are useful in certain situations where more than one drive wheel lacks traction and requires a traction aid.

Some embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A vehicle comprising:
a storage compartment, wherein the storage compartment is disposed below a load floor of a cargo area of the vehicle; and
a traction board cover for the storage compartment, wherein the traction board cover defines a length and a width, wherein the length is greater than the width;
wherein the traction board cover defines a first major surface and a second major surface, wherein at least one of the first major surface and the second major surface defines a first plurality of lugs extending away from the at least one of the first major surface or the second major surface, and
wherein the traction board cover defines at least one handle, wherein the at least one handle is at least one of formed into the traction board cover or collapsible to be flush with or below the at least one of the first major surface and the second major surface.

2. The vehicle of claim 1, wherein the traction board cover is removable and configured to flex under a weight of at least one wheel of the vehicle.

3. The vehicle of claim 1, wherein the storage compartment defines a rim proximate a top of the storage compartment, wherein the traction board cover is configured to be seated on the rim within a recess of the load floor.

4. The vehicle of claim 1, wherein the traction board cover is formed of a plastic material reinforced with at least one of fibers or particulate fillers.

5. The vehicle of claim 1, where the at least one of the first major surface and the second major surface defining the first plurality of lugs extending away from the at least one of the first major surface or the second major surface comprises:
the first major surface defining the first plurality of lugs extending away from the first major surface, and the second major surface defining a second plurality of lugs extending away from the second major surface.

6. The vehicle of claim 5, wherein the first plurality of lugs extends a first distance away from the first major surface, the second plurality of lugs extends a second distance away from the second major surface, and wherein the first distance is greater than the second distance.

7. The vehicle of claim 1, wherein the length is defined between a first end of the traction board cover and a second end of the traction board cover, and wherein the first end of the traction board cover defines a concavity for use as a shovel.

8. The vehicle of claim 7, wherein the second end of the traction board cover defines a handle that, in combination with the concavity of the first end, renders the traction board functional as a shovel.

9. The vehicle of claim 1, wherein a mid-section of the traction board cover defines a first thickness, wherein the length is defined between a first end of the traction board cover and a second end of the traction board cover, wherein the first end of the traction board cover tapers from the first thickness to a second thickness, and wherein the second thickness is less than the first thickness.

10. The vehicle of claim 1, wherein the length is defined between a first end of the traction board cover and a second end of the traction board cover, wherein the traction board cover defines one or more ribs extending between the first end and the second end.

11. The vehicle of claim 1, wherein the traction board cover comprises a first traction board cover, wherein the vehicle further comprises:
a second traction board cover for the storage compartment, wherein the traction board cover defines a length and a width, wherein the length is greater than the width.

12. A traction board for a vehicle comprising:
a traction board body, wherein the traction board body defines a first major surface and a second major surface, wherein the traction board body defines a first end, a second end, a mid-section between the first end and the second end, and a perimeter about the traction board body;
a first plurality of lugs extending away from at least one of the first major surface or the second major surface; and
at least one handle defined within the traction board body,
wherein the traction board body is configured to be received within a recess of a vehicle load floor, and wherein the traction board body covers a storage compartment below the vehicle load floor.

13. The traction board of claim 12, wherein the traction board body is formed of a plastic material reinforced with at least one of fibers or particulate fillers.

14. The traction board of claim 12, further comprising a second plurality of lugs extending away from another of the at least one of the first major surface or the second major surface.

15. The traction board of claim 14, wherein the first plurality of lugs extends a first distance away from the first major surface and the second plurality of lugs extends a second distance away from the second major surface, and wherein the first distance is greater than the second distance.

16. The traction board of claim 12, wherein the first end of the traction board cover defines a concavity for use as a shovel.

17. The traction board of claim 16, wherein the second end of the traction board defines a handle that, in combination with the concavity of the first end, renders the traction board functional as a shovel.

18. The traction board of claim 12, wherein a mid-section of the traction board body defines a first thickness, wherein the first end of the traction board body tapers from the first thickness to a second thickness, and wherein the second thickness is less than the first thickness.

19. The traction board of claim 12, wherein the traction board body defines one or more ribs extending between the first end and the second end.
